(19) United States
(12) Patent Application Publication
(10) Pub. No.: US 2002/0117815 A1
(43) Pub. Date: Aug. 29, 2002

(54) Gaskets utilizing polymers having a novel cure system

(76) Inventors: Kevin Grant Suddaby, Morrisville, NC (US); Venkataram Krishnan, Cary, NC (US)

Correspondence Address: MYERS BIGEL SIBLEY & SAJOVEC, PO BOX 37428, RALEIGH, NC, 27627, US

(21) Appl. No.: 09/747,905

(22) Filed: Dec. 22, 2000

(51) Int. Cl. F16J 15/08

(52) U.S. Cl. 277/650

(57) ABSTRACT

The present invention provides a gasket using a polymer composition capable of being cured or crosslinked in the absence or without the use of conventional cure systems. The polymer is formed from olefinically unsaturated monomers. Such polymer includes additional functionality provided by a chelating monomer. Methods of making gaskets or other articles of manufacture either using a beater additions process or a saturation process are also provided.

### FIELD AND BACKGROUND OF THE INVENTION

The present invention relates to polymer compositions useful in making gaskets and other articles manufactured using beater addition or saturation processes. The compositions are particularly useful when there is a need for an alternative to sulfur-based cure systems.

In general, many conventional polymer compositions used in gaskets, films, coatings and adhesives utilize sulfur-based cure systems. These cure packages are suitable for systems in which the polymer contains residual unsaturation (e.g. those containing polymers formed from conjugated diene monomers). Sulfur-based links are introduced during the crosslinking of the polymer composition. In addition to sulfur, accelerators such as amines, thiazoles, sulfonamides, dithiocarbamates and thiurams are utilized.

Typically, sulfur-based crosslinking is used in gasket applications to impart desirable properties to the gasket such as strength, crush resistance, and chemical resistance. Nevertheless, it would be desirable to eliminate the use of sulfur-based crosslinking agents and accelerators because these have the potential for contamination of the gaskets. Curing agents or curing agent residues that are not bound to the polymer chains can bloom to the surface of the polymer. In practice this is sometimes seen as sulfur blooming. Blooming from the cure system can alter gasket performance properties where it can interfere with adhesion or sealing properties.

In applications where sulfur-based crosslinking is undesirable or unsuitable (such as those based on polymers not containing residual unsaturations) alternative cure systems are required. One alternative to sulfur-based curing is peroxide curing, although this is not widely practiced. There are handling issues associated with the peroxides used and it is unsuitable in many applications because it is difficult to obtain an adequate cure. Another alternative to sulfur-based curing is the incorporation of reactive functionality into a polymer. Conventionally such polymers are obtained through the use of, for example, derivatives of N-methylol acrylamide, or glycidyl methacrylate. These may improve performance in some applications, but it is nonetheless difficult to get the desired performance using these systems, particularly with respect to chemical resistance (e.g., glycol resistance). Furthermore, the generation of undesirable residues such as formaldehyde or other volatile organic compounds is associated with cure systems based on use of several of these functional monomers, particularly the N-methylol acrylamide derivatives.

There, however, continues to be a need for polymers that cure using alternative cure systems. Such polymers should have the desirable characteristics of the conventional polymers, and impart the desired properties (e.g. sealability, strength, crush resistance, oil and glycol resistance, and heat aging resistance) while obviating the undesirable features of polymers cured using conventional sulfur-based systems, for example, sulfur blooming.

### SUMMARY OF THE INVENTION

To these ends, and to other objects and advantages, the present invention provides gaskets utilizing a polymer composition capable of being cured or crosslinked in the absence or without the use of conventional cure systems. The polymer composition is formed from at least one olefinically unsaturated monomer. Such polymer composition includes additional functionality provided by a chelating monomer. As an example, a suitable chelating monomer is an acetoacetoxy functionalized monomer. Such a polymer composition can then be crosslinked with a polyvalent metal ion crosslinking agent without the use of conventional curing agents and/or accelerators. Methods of making gaskets or other articles either using a beater addition process or a saturation process are also provided.

### DETAILED DESCRIPTION OF THE INVENTION

The present invention will now be described more fully hereinafter, in which preferred embodiments of the invention are shown. This invention may, however, be embodied in different forms and should not be construed as limited to the embodiments set forth herein. Rather, these embodiments are provided so that this disclosure will be thorough and complete, and will fully convey the scope of the invention to those skilled in the art.

The polymer composition is formed from olefinically unsaturated monomers wherein additional functionality is provided by a chelating monomer. Suitable olefinically unsaturated monomers include conjugated dienes, α,β-unsaturated carboxylic acids, their anhydrides, and their aliphatic, alicyclic, aromatic and heteroaromatic (partial) esters or (partial) amides such that the carbon skeletons of the base alcohols and amines of the esters and amides preferably contain from about 1 to 20 carbon atoms in their carbon skeletons. Other suitable olefinically unsaturated monomers include α,β-unsaturated nitriles, vinyl aromatics, vinyl halides, and vinyl esters of aliphatic carboxylic acids preferably having between about 2 and 20 carbon atoms, and vinyl ethers of aliphatic, alicyclic, aromatic, and heteroaromatic alcohols preferably having from 1 to 18 carbon atoms.

Suitable α,β-unsaturated carboxylic acids include itaconic, maleic, fumaric, and preferably acrylic and methacrylic acid.

Suitable esters or amides include methyl (meth)acrylate, ethyl (meth)acrylate, propyl (meth)acrylate, isopropyl (meth)acrylate, butyl (meth)acrylate, sec-butyl (meth)acrylate, tert-butyl(meth)acrylate, 2-ethylhexyl (meth)acrylate, glycidyl (meth)acrylate, hydroxyethyl (meth)acrylate, hydroxypropyl (meth)acrylate, hydroxybutyl (meth)acrylate, β-carboxyethyl acrylate, monomethyl maleate, dimethyl maleate, monooctyl maleate, monomethyl itaconate, dimethyl itaconate, di(ethylene glycol) maleate, di(ethylene glycol) itaconate, 2-hydroxyethyl methyl fumarate, ethylene glycol di(meth)acrylate, hexamethylene glycol di(meth)acrylate, maleimide, 3-chloro-2-hydroxybutyl methacrylate, dimethylaminoethyl (meth)acrylate and their salts, 2-sulfoethyl (meth)acrylate and their salts, diethylaminoethyl (meth)acrylate and their salts, methoxy polyethylene glycol mono(meth)acrylate, tert-butylaminoethyl (meth)acrylate and their salts, benzyl (meth)acrylate, isobornyl (meth)acrylate, isodecyl (meth)acrylate, cyclohexyl (meth)acrylate, lauryl (meth)acrylate, methoxyethyl (meth)acrylate, hexyl (meth)acrylate, stearyl (meth)acrylate, allyl (meth)acrylate, ethoxylated nonylphenol (meth)acrylate, tridecyl (meth)acrylate, caprolactone (meth)acrylate, propoxylated allyl (meth)acrylate, tetrahydrofurfuryl (meth)acrylate, (meth)acrylamide, 2-acrylamido-2-methylpropanesulfonic acid, N-isopropyl(meth)acrylamide, tert-butyl(meth)acrylamide, N,N′-methylene-bis-(meth)acrylamide, N,N-dimethyl(meth)acrylamide, and N-methylol(meth)acrylamide.

Suitable conjugated dienes include, but are not limited, to C₄ to C₉ dienes such as for example butadiene monomers such as 1,3-butadiene, 2-methyl-1,3 butadiene and the like. Blends or copolymers of the diene monomer can be used. A particularly preferred conjugated diene is 1,3-butadiene. In one embodiment, it is preferred that the polymer composition is formed from olefinically unsaturated monomers wherein the polymer contains at least one conjugated dience, such as described in U.S. Ser. No.[Attorney Docket No. 5458-277] ______ filed on Nov. 9, 2000 the disclosure of which is incorporated herein by reference in its entirety. In another embodiment, the use of a conjugated diene is avoided to improve ageing and heat resistance characteristics Suitable vinyl aromatic monomers include styrene, α-methylstyrene, p-methylstyrene, p-methoxystyrene, vinyl toluene, chlorostyrene, vinyl benzylchloride, vinyl pyridines, and vinyl naphthalene.

Suitable vinyl halides include vinyl chloride and vinylidene chloride.

Suitable unsaturated nitriles include acrylonitrile and methacrylonitrile.

Preferably, the chelating monomer contains a chelating functionality with the structure

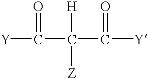

wherein Z is

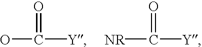

or Y″, and Y, Y′ and Y″ are independently selected from the group consisting of NR″R′, OR′ or R′ wherein R, R′ and R″ are independently selected from the group consisting of hydrogen and aliphatic, alicyclic, aromatic and heteroaromatic groups and at least one of Y, Y′ and Z contains an olefinic unsaturation. Such a chelating monomer permits incorporation into the polymer chain through the olefinic unsaturation.

Suitable chelating monomers include esters of acetylacetic and diacetylacetic acids such as acetoacetoxyethyl (meth)acrylate, acetoacetoxypropyl (meth)acrylate, di acetoacetoxyethyl (meth)acrylate, diacetoacetoxypropyl (meth)acrylate, vinyl acetoacetate, vinyl diacetoacetate, allyl acetoacetate, and allyl diacetoacetate.

One method of preparing the polymer composition is to use emulsion polymerization so that the polymer composition is obtained in the form of a polymer latex. Conventional free radical initiation systems used in emulsion polymerization may be used in preparing these polymer latices. These initiation systems include, for example, peroxidic and diazo compounds such as ammonium persulfate, potassium persulfate, sodium persulfate, tert-butyl hydroperoxide, hydrogen peroxide, peroxydiphosphates, 4,4′-azobis(4-cyanovaleric acid), 2,2′-azobisisobutyronitrile, as well as redox systems known to one skilled in the art.

Conventional surfactants and emulsifying agents can be employed in making the polymer. Polymerizable surfactants that can be incorporated into the polymer also can be used. For example, anionic surfactants can be selected from the broad class of sulfonates, sulfates, ethersulfates, sulfosuccinates, phosphates and the like, the selection of which will be readily apparent to anyone skilled in the art. Nonionic surfactants may also be used to improve the latex performance. Examples of nonionic surfactants are readily known to one skilled in the art and typically, include the family of alkylphenoxypoly(ethyleneoxy)ethanols where the alkyl group typically varies from C₇ -C₁₈ and the ethylene oxide units vary from 4-100 moles. Various preferred surfactants in this class include the ethoxylated octyl and nonyl phenols. Ethoxylated alcohols are also desirable surfactants. A typical anionic surfactant is selected from the diphenyloxide disulfonate family, such as benzenesulfonic acid, dodecyloxydi-, disodium salt. In addition to, or in place of the surfactants, a polymeric stabilizer may be used in the composition of the invention.

Additional ingredients which may be used include, but are not limited to, other chelating agents (e.g., ethylenediaminetetraacetic acid), dispersants (e.g., salts of condensed naphthalenesulfonic acid); buffering agents (e.g., ammonium hydroxide); and polymerization inhibitors (e.g., hydroquinone).

Chain transfer agents (e.g., carbon tetrachloride, butyl mercaptan, bromotrichloromethane, n-dodecyl mercaptan and t-dodecyl mercaptan) may also be used in the invention. The polymer is crosslinked with addition of a source of polyvalent metal ions. Suitable polyvalent metal ions include Al³⁺, Ba²⁺, Ca²⁺, Co²⁺, Co³⁺, Cu²⁺, Fe²⁺, Fe³⁺, Mg²⁺, Mn²⁺, Mn³⁺, Mn⁴⁺, Ni²⁺, Pb²⁺, Pb⁴⁺, Sn²⁺, Sn⁴⁺, Sr²⁺, Ti²⁺, Ti³⁺, Ti⁴⁺, Zn²⁺, and Zr⁴⁺. Polyvalent metal ion crosslinking agents known to be effective in the ionic crosslinking of carboxylated polymers such as zinc, calcium, lead, and magnesium oxides may be particularly useful in polymers containing chelating and carboxylic functionalities. Both ionic crosslinking and crosslinking by chelation can occur with these polymers.

Typically, the polymer composition comprises about 5 to about 99.9 percent by weight of at least one olefinically unsaturated monomer, and from about 0.1 to about 30 percent by weight of the composition of the chelating monomer. The polyvalent metal ion crosslinking agent is added in the amount of from about 0.1 to about 45 percent by weight of polymer.

Various fibers and fillers typically used in gasket applications are added to the composition. The selection of such fibers and fillers will be within one skilled in the art. Fibers can be inorganic or organic and natural or synthetic. The fibers suitably have a length in the range of from about 1 to about 15 millimeters (mm). A preferred length is from about 1 to about 5 mm. Suitable fiber diameters are in the range of from about 4 to about 50 microns, and preferably, from about 4 to about 25 microns. Suitable synthetic materials which can be made into fibers and used with the gaskets of the present invention can be selected from the group consisting of polyolefins, polyesters polyaramid, polyvinylidene chloride, polyvinyl chloride, polyimide, polybenzimidazole, polyamide-imide, polyether-imide, polyacrylate, fluorinated polypropylene, fluorinated polyethylene, fluorinated copolymers of polyethylene and polypropylene, fluorinated polyolefins, polyamides, polyesters, and aromatic polyamides. Preferred fibers can be selected from the group consisting of cellulosic fibers, mineral wool, glass, polyaramid, polyacrylate, polyester, nylon polypropylene, acrylic, ceramic, and carbon fibers.

Suitable fillers can be selected from the group consisting of clay, calcium silicate, talc, vermiculite, calcium carbonate, mica, diatomaceous earth, and silica. Preferred fillers which can be selected to be used with the instant gaskets can be clay, talc and mica. Various fibers, fillers, and other additives are incorporated depending on the end-performance requirements, the selection of which will be within the skill of one in the art.

The primary purpose of a gasket is to seal or provide a barrier at the interfaces of imperfect or incompatible parts. The proper gasket selection is made after a careful review of the conditions the gasket is likely to encounter. This includes the condition of the flange being sealed, the amount of torque placed on the flange, the fluids that the gasket may encounter and the temperature to which the gasket is exposed. In order to obtain the best compression resistance, a curative is incorporated to cross-link the polymer under elevated temperatures. The specific crosslink temperature can be obtained during a secondary treatment to the gasket before shipping, or it may be obtained once the gasket is in place. For butadiene copolymers, the conventional cure package consists of sulfur, accelerator, and zinc oxide (vulcanizing package). While this cure package is effective in providing the required performance properties, it also has several negative features associated with the use of sulfur. Namely, excess sulfur blooms to the surface of the gasket with time. This causes a dusty residue that interferes with post treatments such as a release coat, laminating adhesive, or trade-marking. Additionally, excess sulfur is a nuisance to plant workers during the post-curing process when excessive smoke and fumes are generated. Excessive sulfur also inhibits the cure mechanism of post-added silicone beading. Excess sulfur does not improve the overall cure of the gasket and is a negative expense. Thus use of the polymer of the present invention obviates the need to use sulfur in the cure package

Articles of manufacture such as gaskets of the present invention can be manufactured using either a beater addition process or a saturation process. The beater addition process is described in U.S. Pat. No. 2,759,813 to Feigley, the disclosure of which is incorporated by reference in its entirety. In the beater addition process, a slurry of at least one fiber in water is mixed with the polymer composition. This slurry also often contains one or more fillers. Polyvalent metal ion crosslinking agent may optionally be included, and some amount of curing may occur while the slurry is further processed. The polymer composition in the slurry is destabilized and precipitated to form a destabilized solid material (furnish). The destabilized solid material is separated out and collected and then processed into sheet (“wet-laying”) by removing excess water via a cylinder machine, a fourdrinier, or similar processing equipment. Additional water is pressed out of the sheet with vacuum generally being applied to enhance water removal. The sheet is then further dried in drying ovens or on steam cans. The dried sheet is then generally formed (e.g., calendared) into gasketing paper having the desired density. The steps of drying and forming may be concurrent. Gaskets of the desired shape can then be stamped out of the gasketing paper and cured utilizing a polyvalent metal ion crosslinking agent. Optionally, the gasketing paper can be cured and the gasket then stamped out of the paper.

In the saturation process, a gasket substrate including fiber and filler is provided and passed through a dispersion of the polymer composition. The impregnated gasket substrate is dried, then cured and the substrate cut into a gasket shape. The drying and curing steps can occur substantially simultaneously. Also, the gasket substrate can be dried and cut into the desired gasket shape and then cured. Curing in any of the above methods preferably occurs using a polyvalent metal ion.

It is recognized that other articles than gaskets can be made utilizing the composition of the present invention and either the beater addition process or the saturation process. For example, friction papers such as used in brake pads, non-woven belting and the like can be manufactured.

The following examples are merely illustrative of the invention, and are not limiting thereon.

### EXAMPLE 1

153 phm (parts per hundred monomer) of demineralized water, 2.75 phm of sodium dodecylben-benzenesulfonate, 0.05 phm of the ammonium salt of EDTA, 0.2 phm of the sodium salt of condensed naphthalene sulfonic acid, 0.1 phm of tetrapotassium pyrophosphate, 0.6 phm of tert-dodecylmercaptan, 58 phm 1,3-butadiene, 36 phm acrylonitrile, 3 phm methacrylic acid, and 3 phm of acetoacetoxyethyl methacrylate were charged into a reactor. The temperature of the reactor was raised to 105° F. and 0.025 phm of potassium persulfate was added. The following temperature adjustments were made: 110° F. at 30 minutes, 115° F at 1.25 hrs, 120° F. at 2 hours, 125° F. at 7 hours, 130° F. at 8 hours and 140° F. at 9.5 hours. At 13.5 hours the 0.72 phm of triethanolamine and 0.25 phm of di-tert-amylhydroquinone were added and the conversion determined to be 91.7%. The pH was adjusted to 7.3 using triethanolamine, and the latex was concentrated to 44.4% solids. The viscosity of the latex as determined to be 44 cPs.

### EXAMPLE 2

A polymer latex was prepared as in Example 1 using 0.8 phm of tert-dodecylmercaptan rather than 0.6 phm. The final conversion was determined to be 90.4%. The pH was adjusted to 7.5 and the latex was concentrated to 45% solids. The viscosity was 40 cPs.

### EXAMPLE 3

A polymer latex was prepared as in Example 1 using 1 phm of tert-dodecylmercaptan except the final conversion was determined to be 90.3%. The pH was adjusted to 7.5, and it was concentrated to 45%. The viscosity was determined to be 40 cPs.

### EXAMPLE 4

Gasket Preparation:

A typical gasket recipe contains approximately 11% fiber, 65% filler, 16% latex (includes cure package), and 8% miscellaneous ingredients (flocculants, retention aids, antioxidants, etc.). The fibers and fillers are slurried in water to approximately 1.5% consistency. The latex is added to the slurried fiber/filler mix and is chemically destabilized onto the fiber/filler surfaces. This process binds the ingredients together. The slurry is then pumped to the head box and drained on the forming wire. Additional water is removed through heated drying cans.

For the laboratory testing, the gaskets were prepared using the procedure above, except a hand sheet forming headbox was used to drain the water from the slurry. The gaskets were dried on a rotating drum drier for 10 minutes at 200° F. and then subsequently cured in a forced air oven for 10 minutes at 350° F. The chemical used for destabilization was alum. Alum was added until the aqueous solution became clear; a level of approximately 40 weight percent on the basis of latex solids.

Fluid Testing:

Cured gaskets are cut into 1″×6″ test strips for tensile strength determination. Caliper is recorded on all test samples. Gasket strips are separated for testing in the following fluids and times:

1. ASTM Oil #1 (aromatic oil)—5 hours @ 280° F.

2. ASTM Oil #3 (aliphatic oil)—5 hours @ 280° F.

3. Commercially available antifreeze cut 1:1 with water (“Glycol” in Table 4)—5 hours @ rapid boil.

After the designated fluid submersions, the test strips are blotted with high absorbency blotting paper, weighted and caliper recorded. Tensile strength is determined using a standard tensile tester with a clamp separation of 4″ and an extension rate of 6″/minute.

Gaskets were prepared as described above without the use of a sulfur cure package using the lattices prepared as described in Examples 1, 2 and 3. Crosslinking by chelation results from metal salts introduced in the gasket preparation procedure. For comparative purposes, a series of control gaskets were made as described above using the sulfur based cure system. The control gaskets were made using Tylac® 68074-00,Tylac® 68520-00, Tylac® 68513-00, commercial lattices used in gasketing applications and available from Reichhold, Inc., Research Triangle Park, North Carolina. Table 1 contains a summary of the tensile data from these gaskets both dry and after fluid testing. The gaskets prepared according to this invention provide suitable performance without use of a sulfur cure package.

TABLE 1
Tensile Strength (psi)

| Gasket | None (Dry) | Glycol | ASTM Oil #1 | ASTM Oil #3 |
|---|---|---|---|---|
| 68520-00 (1) | 892 | 168 | 996 | 904 |
| 68520-00 (2) | 909 | 124 | 944 | 869 |
| 68074-00 | 897 | 131 | 994 | 882 |
| 68513-00 | 1294 | 386 | 1248 | 1074 |
| Example 1 | 1036 | 629 | 1499 | 1332 |
| Example 2 | 1168 | 740 | 1583 | 1580 |
| Example 3 | 1224 | 389 | 1290 | 1171 |

In the specification and examples, there have been disclosed typical preferred embodiments of the invention and, although specific terms are employed, they are used in a generic and descriptive sense only and not for purposes of limitation of the scope of the invention being set forth in the following claims.

That which is claimed:

1. A gasket in which the polymer component thereof contains a polymer formed from olefinically unsaturated monomers wherein additional functionality is provided by a chelating monomer.

2. The gasket according to claim 1, wherein the chelating monomer has the structure 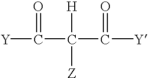
wherein Z is 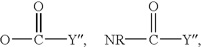
or Y″, and Y, Y′ and Y″ are independently selected from the group consisting of NR″R′, OR′ or R′ wherein R, R′ and R″ are independently selected from the group consisting of hydrogen and aliphatic, alicyclic, aromatic and heteroaromatic groups and at least one of Y, Y′ and Z contains an olefinic unsaturation.

3. The gasket according to claim 2, wherein the chelating monomer is an acetoacetoxy or diacetoacetoxy monomer.

4. The gasket according to claim 3, wherein the acetoacetoxy monomer is selected from the group consisting of esters of acetylacetic and diacetylacetic acids.

5. The gasket according to claim 1, wherein the polymer is crosslinked with a polyvalent metal ion crosslinking agent.

6. The gasket according to claim 1, wherein the polymer contains at least one conjugated diene monomer.

7. The gasket according to claim 6, wherein the conjugated diene monomer is a C₄ to C₉ diene.

8. The gasket according to claim 1, wherein the polymer contains at least one α,β-unsaturated carboxylic acid monomer.

9. A method of making a substrate using a beater additions process comprising the steps of:
(a) forming a slurry of at least one fiber in water and of a polymer composition comprising at least one olefinically unsaturated monomer and additional functionality provided by a chelating monomer;
(b) destabilizing the slurry;
(c) separating out and collecting destabilized solid material to provide a solid mass;
(d) drying the solid mass;
(e) forming the solid mass into a substrate; and
(f) curing the polymer composition utilizing a polyvalent metal ion crosslinking agent to crosslink the polymer composition to provide the substrate.

10. The method of claim 9, wherein the step of forming the solid mass of step (e) includes cutting the substrate into a predetermined shape of an article of manufacture.

11. The method of claim 10 wherein the article of manufacture is a gasket.

12. The method of claim 9, further including the additional step (g) of cutting the cured substrate into a predetermined shape of an article of manufacture.

13. The method of claim 12, wherein the article of manufacture is a gasket.

14. The method according to claim 9, wherein the chelating monomer has the structure 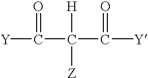
wherein Z is 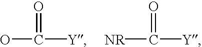
or Y″, and Y, Y′ and Y″ are independently selected from the group consisting of NR″R′, OR′ or R′ wherein R, R′ and R″ are independently selected from the group consisting of hydrogen and aliphatic, alicyclic, aromatic and heteroaromatic groups and at least one of Y, Y′ and Z contains an olefinic unsaturation.

15. The method according to claim 14, wherein the chelating monomer is an acetoacetoxy or diacetoacetoxy monomer.

16. The method according to claim 15, wherein the acetoacetoxy monomer is selected from the group consisting of esters of acetylacetic and diacetylactic acids.

17. The method according to claim 9, wherein the olefinically unsaturated monomer includes a C₄ to C₉ diene.

18. The method according to claim 17, wherein the C₄ to C₉ diene is 1,3-butadiene.

19. The method according to claim 17, wherein in addition to the C₄ to C₉ diene monomer, the polymer contains an α,β-unsaturated nitrile monomer.

20. The method according to claim 17, wherein the polymer contains at least one α,β-unsaturated carboxylic acid monomer.

21. A method of making an article of manufacture by a saturation process comprising the steps of:
(a) passing a substrate through a dispersion of a polymer composition wherein the polymer composition is formed from at least one olefinically unsaturated monomer and has additional functionality provided by a chelating monomer;
(b) drying the substrate impregnated with the polymer composition; and
(c) curing the polymer composition utilizing a polyvalent metal ion crosslinking agent to crosslink the composition to form the article of manufacture.

22. The method according to claim 21 further including step (d) of cutting the substrate into a predetermined shape of an article of manufacture.

23. The method according to claim 22 wherein the article of manufacture is a gasket.

24. The method according to claim 21, wherein after step (b), the substrate is cut into a predetermined shape of an article of manufacture prior to step (c).

25. The method according to claim 24 wherein the article of manufacture is a gasket.

26. The method according to claim 21, wherein the chelating monomer has the structure 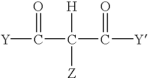
wherein Z is 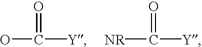
or Y″, and Y, Y′ and Y″ are independently selected from the group consisting of NR″R′, OR′ or R′ wherein R, R′ and R″ are independently selected from the group consisting of hydrogen and aliphatic, alicyclic, aromatic and heteroaromatic groups and at least one of Y, Y′ and Z contains an olefinic unsaturation.

27. The method according to claim 26, wherein the chelating monomer is an acetoacetoxy or diacetoacetoxy monomer.

28. The method according to claim 27, wherein the acetoacetoxy monomer is selected from the group consisting of esters of acetylacetic and diacetylactic acids.

29. The method according to claim 21, wherein the olefinically unsaturated monomer includes a C₄ to C₉ diene.

30. The method according to claim 29, wherein the C₄ to C₉ diene is 1,3-butadiene.

31. The method according to claim 29, wherein in addition to the C₄ to C₉ diene monomer, the polymer contains an α,β-unsaturated nitrile monomer.

32. The method according to claim 29, wherein the polymer contains at least one α,β-unsaturated carboxylic acid monomer.
